(19) United States
(12) Patent Application Publication
(10) Pub. No.: US 2016/0212242 A1
(43) Pub. Date: Jul. 21, 2016

(54) SPECIFICATION AND DEPLOYMENT OF MEDIA RESOURCES

(71) Applicant: Incident Technologies, Inc., San Francisco, CA (US)

(72) Inventor: Idan Beck, San Francisco, CA (US)

(21) Appl. No.: 14/602,212

(22) Filed: Jan. 21, 2015

(51) Int. Cl. H04L 29/06; G06F 3/16; G06F 3/0484

(52) U.S. Cl. CPC H04L 67/42; G06F 3/04842; G06F 3/04845; G06F 3/165

(57) ABSTRACT

Deploying media resources using an optimized specification. A data specification layer allows for media resources to be defined, points to locations of the resource objects within a media repository, and defines a structure and context for the media resources to be deployed in a structured way within a media environment. The optimized specification allows for a collaborative music creation environment, wherein media resources such as music notation data and samples may be added and removed by one or more users collaborating on a single document. The document can then be specified and deployed using the same specification format, as well as shared among users.

### TECHNICAL FIELD

The present technology pertains to the specification and presentation of media resources, and specifically to providing a framework for deploying media resource assets within software applications in a structured and efficient way.

### BACKGROUND

When designing software related to media creation or presentation, deploying media resources is an important consideration. For example, within a music creation application, a user may be presented with a library of sounds to make use of in writing and recording a piece of music. Those sounds are resources which must be defined, listed, and, if a user decides to make use of them, deployed within the application in various ways. It's therefore important for the developer of the application to consider how those sounds can be listed and deployed within the application in an efficient, structured way. Similarly, a browser-based collaborative video editing application may allow users to move around individual video clips to form a full video. The developers may have to consider how to list the video clips, structure them in a particular way within the video, and present them so that multiple users can view them and edit them. It also has to consider where the video clips can be retrieved from within the developer's server storage.

In addition, media assets may each have their own important pieces of information associated with them. A sound sample of a child's voice may have waveform data, length, and other pieces of information associated with it to be used within the music application. A developer may have to effectively develop its own engine for dealing with all these pieces of information within a given media asset.

Many developers often resort to developing their own internal repositories and engines for dealing with media data and deployment. Alternatively, developers may use third party repositories and engines that require catering their workflow to a particular narrow method of retrieval, deployment and presentation of media assets. Both of these methods require additional time, effort, and constraints, and still provide frameworks that are of limited, narrow use to a specific developer. There is a lack of efficiency, optimization, and compatibility in the present state of art which is absent a streamlined, universal framework for media asset deployment.

### SUMMARY

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present technology can specify a plurality of media elements and media resources for arrangement within a media application, and then deploy media resource objects pertaining to the media resources for presenting within the media application. The media application, elements, and resources can pertain to any possible media environment, including at least environments for the playback, composition, and editing of music, video, images, animation, interactive programs, web pages, and more. In some embodiments, a media application may be a collaborative environment for multiple users to compose and/or edit a media presentation or media piece. In some embodiments, the media application pertains specifically to a music composition and editing application. The application can pertain to a music learning and educational tool. In some embodiments, the media elements and media resources are elements, which define a song structure, notation data, instruments, waveforms, and other elements needed for a music composition environment. The particular formatting of specification instructions for media allows for a powerful, flexible, efficient, and universal way for describing and presenting media across many platforms.

A media application can request instructions from a media server for presenting media within the media application. In response, the media server sends a specification instruction set to the client device. In some embodiments, the specification instructions are a formatted set of hierarchical data. The formatting may be in a form that presents definitions and locations of resources for deployment, and presents a structured way for presenting those resources.

Specification instructions can define a wide variety of media elements. In some embodiments, the media elements can be song elements, such as tracks, measures, instruments, and clips. The media elements can also be audio elements, including audio nodes, effect nodes such as delay and reverb effects, audio samples, and more. In some embodiments, the media elements can be instrument elements, including oscillators, envelopes, filters, and other building blocks for audio synthesis. Additional types of media elements similarly may exist in different embodiments for video, images, three-dimensional animation rendering, and more.

The requested specification instructions are processed via a processing engine, which may be part of the media application on the client device or may be placed on the media server. The processing engine reads the specification instructions and organizes the media elements such that they are prepared for deployment within the media application environment. The processing involves reading the definitions of the media elements, including parameters relating to how the media elements are to be presented. The processing also involves organizing according to the nested structure of elements present in the formatted specification instructions. Media resource items may contain assets at specific locations, within a media resource object repository on the server. The corresponding media resource object assets are retrieved from the repository, and transmitted to the media application for client-side presentation according to the processed specification instructions. Assets may be composed of other assets, and such assets are resolved by the media application environment in a similar fashion.

As discussed herein, an exemplary embodiment for the present invention may be a music composition, editing, and playback environment in a media application on the client device. The environment may present a user with a way to load in note data, instrument data, waveforms, and a song structure, which are defined in the specification instructions and located within the repository. This environment may allow a user to rearrange and manipulate the media elements and resources in various ways, and then store them in new specification instructions and files on the server. Similar environments may exist for other types of media. These configurations can allow for remixes, derivative works, and completely new arrangements from specified media.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an exemplary method embodiment;

FIG. 3A and FIG. 3B illustrate exemplary specification elements;

FIG. 4 illustrates an exemplary specification element hierarchy; and

FIG. 5A and FIG. 5B illustrate exemplary system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for an efficient means to define and present media resources and content within an organized, efficient, and universal framework.

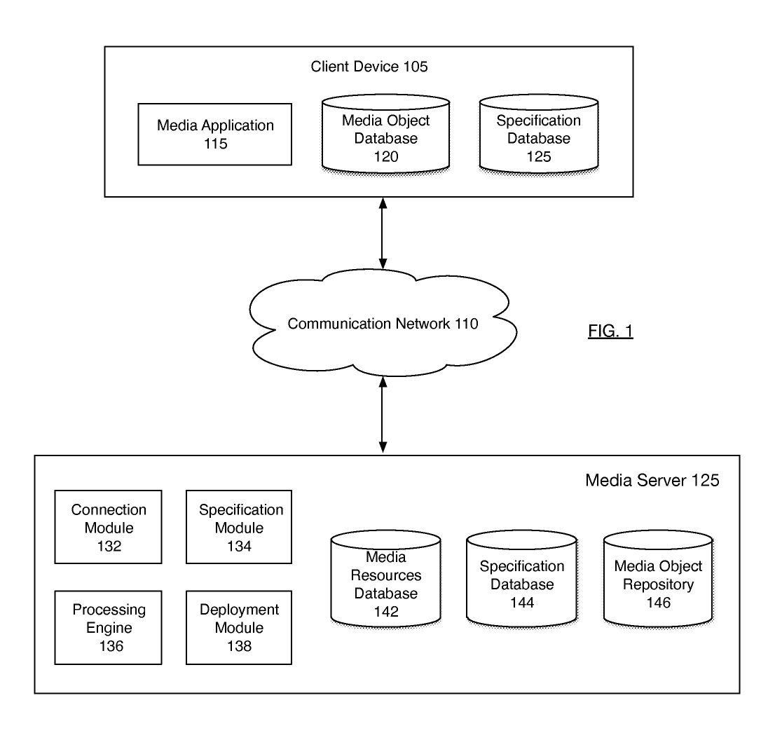

FIG. 1 illustrates an exemplary system configuration 100 in which multiple computing devices can be configured to communicate with each other to process a specification and deploy media resources. Within the exemplary system configuration, one or more client devices and servers can be connected to a communication network 110 and can be configured to communicate with each other through use of the communication network 110. The communication network 110 can be any type of network, including a local area network (“LAN”), such as an intranet, a wide area network (“WAN”), such as the Internet, or any combination thereof. Further, the communication network 110 can be a public network, a private network, or a combination thereof. The communication network can also be implemented using any type or types of physical media, including wired communication paths and wireless communication paths associated with one or more service providers. Additionally, the communication network 110 can be configured to support the transmission of messages formatted using a variety of protocols.

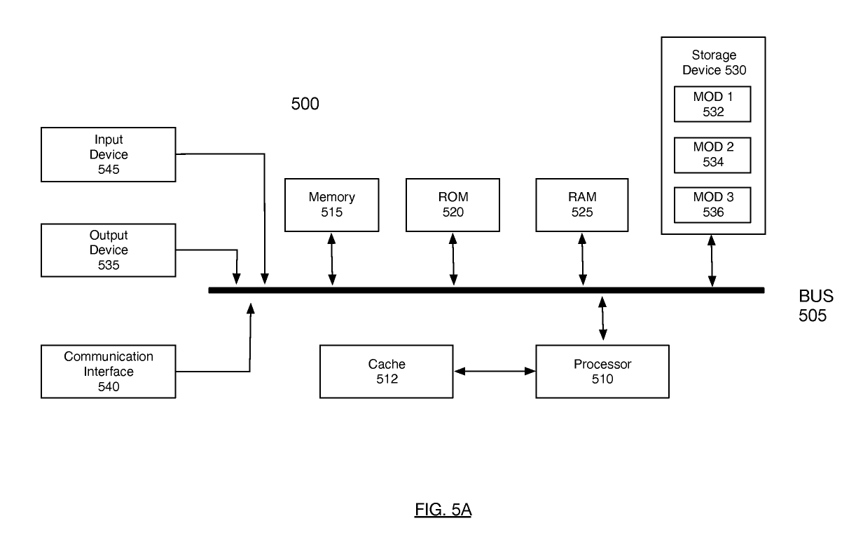

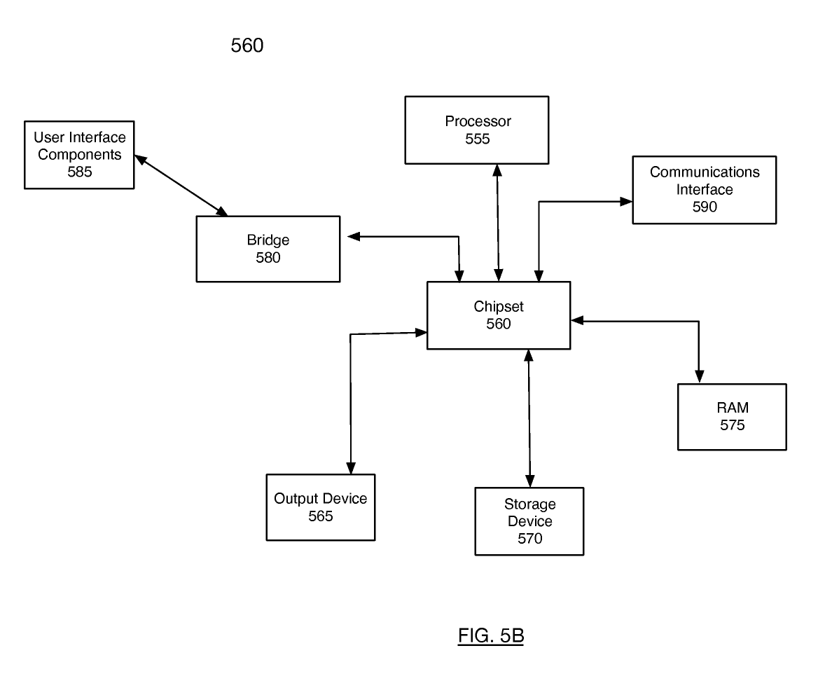

A client device 105 can be any type of general computing device capable of network communication with other computing devices. For example, the client device 105 can be a personal computing device such as a desktop or workstation, a business server, or a portable computing device, such as a laptop, smart phone, tablet personal computer, etc. The client device can include some or all of the features, components, and peripherals of computing device 500 of FIG. 5A.

To facilitate communication with other client devices, the client device 105 can also include a communication interface configured to receive a communication, such as a request, data, etc., from another computing device in network communication with the client device 105 and pass the communication along to an appropriate module running on the client device 105. The communication interface can also be configured to send a communication to another computing device in network communication with the client device 105.

As illustrated, a client device 105 can be configured to communicate with a media server 125 to receive processing instructions and deploy media resources on the client device 105. For example, a media application 115 running on the client device 105 can be configured to communicate with the connection module 132, specification module 134, processing engine 136 and deployment module 138 on the media server 125 to request and receive an instruction set, process it, retrieve and store media resource objects, and deploy them within the environment of the media application 115. A media application can be any application capable of media resource playback, such as a component of a webpage, a plug-in, a client-side application, etc. Media applications may be capable of playing back various media resources. For example, a media application may be configured to render and play back an MP3 file, music notation data, movie files with subtitle data, etc. In some embodiments, media applications may be able to render and play back streaming data, and the media resources described in a specification may be available on the server via a streaming method.

The exemplary system configuration 100 includes a media server 125. The media server 125 includes a connection module 132 that provides a connection between one or more client devices 105 and the media server 125. The media application 115 within a client device 105 may seek a connection with the media server 125 during the course of operation. Such a connection may be sought because the media application is in need of an instruction set, or specification, from the media server 125 in order to acquire the proper media resources needed for presenting or deploying necessary media assets. The connection module 132 assists by establishing the connection allowing the further steps of sending and receiving information to occur between the media server 125 and the client device 105. In some embodiments, the client device 105 must be authenticated on the server via security methods in order to establish a secure connection with a trusted client. The connection module 132 can provide the authentication methods, which may be any known authentication methods for establishing a secure connection.

Within the context of the execution of a media application 115 on the client device 105, media resources may need to be defined and retrieved for use within the application. Media resources, or media assets, are any elements that may be pertinent to the presentation of media in the application. Media resources may be music elements, video elements, image elements, text elements, interactive pieces of code, instructions in various formats, websites and web elements, music notation data and other notation data for media, and more. Within the context of a collaborative music creation application, for example, media resources may include audio samples, music notation data for a song, instruments, track data, tempo data, time signature data and other elements necessary for creating a song on the application. Media resources may take the form of discrete files or sets of files, but may also simply be elements and information, which contribute to a media environment in some way. For example, while music notation data for a song may take the form of a music notation data file, it may also be a specified set of notation elements that can be transmitted to a media application 115 without taking the form of a file. In addition, a file representing music notation data may be converted to be read as specification instructions, and the file may no longer need to be linked as a media resource.

The connection module 132, the media application 115 requests specification instructions, establishes once a connection or an instruction set. Specification instructions are a set of instructions for defining a plurality of media resources, processing them within a processing engine, and deploying them within a media application. Specification instructions are stored within the specification database 144. In one embodiment, specification instructions can be provided in a markup language format. The markup language can be any set of instructions for defining and deploying media resources. In some embodiments, specification instructions may take the form of any formatted document containing a nested hierarchy. Specification instructions contain a series of elements for defining and configuring aspects of media. An element within a specification document can contain descriptive metadata. Elements can also provide and define a structured hierarchy of subelements. For example, within a song element, there may be multiple track elements, each of which has multiple instrument elements. The instrument elements may in turn have multiple oscillator elements for generating the instrument's sound. In this way, subelements nested within elements can provide a structured way to organize and present media resources within an application.

Specification instructions, and a specification layer for media resources, increase computing efficiency by defining, optimizing, and deploying media resources in a structured, consistent way across client devices, and across a wider ecosystem of sites and applications that demand media resources to be presented. By defining customized, optimized ways for media to be understood and used across a wide variety of contexts and devices, the specification as described herein effectively presents media resources in a streamlined, universal framework for asset deployment. Examples of improved efficiency include fewer computing cycles, greater compatibility for different devices, and greater communication across different pieces of software.

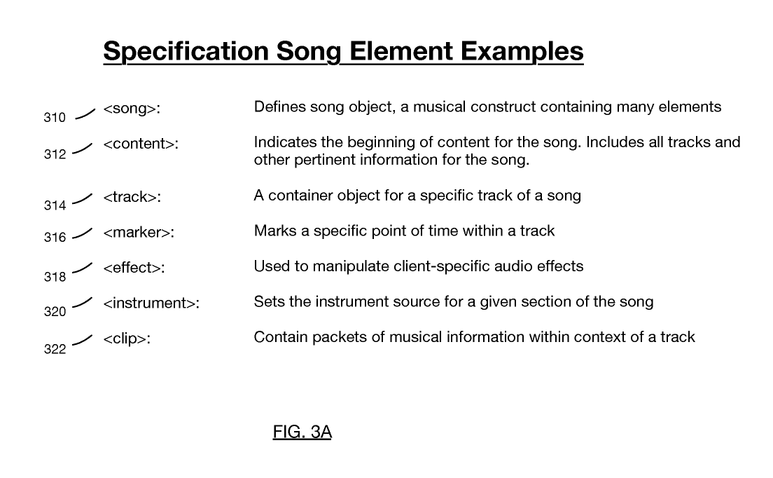

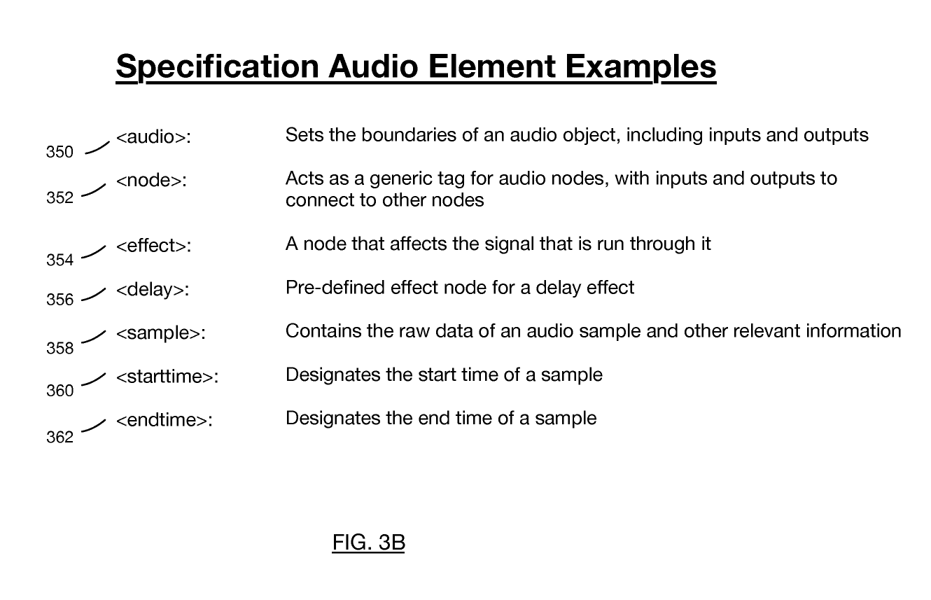

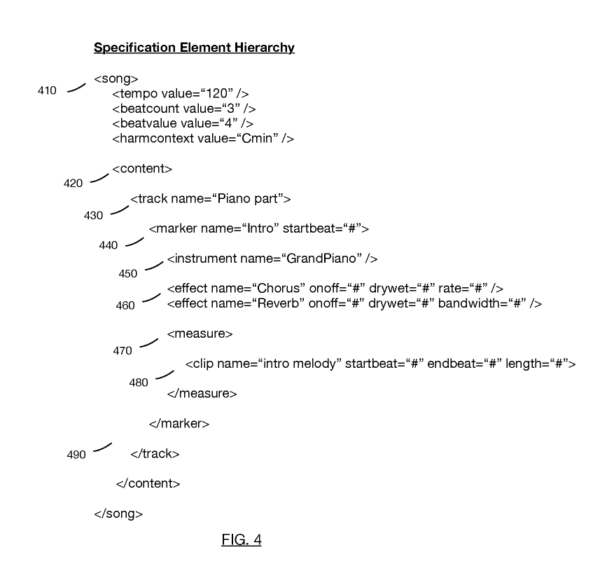

Examples of elements in some embodiments that may be contained within specification instructions follow. A person having ordinary skill in the art will appreciate that the names, specifics, and definitions can vary and take other forms. Elements will be discussed in further detail in FIGS. 3A, 3B and 4.

Song elements may include arrangement elements for a song and other elements pertinent to the song. A <song> element defines a song object, which is a musical construct containing multiple elements. The <song> element can have additional global elements such as <tempo>, which indicates the tempo of the song in beats per minute. A <content> element indicates the beginning of content for the song, and includes all tracks and pertinent information for the song. A <track> element is a container object for a specific track of a song. There may be as many tracks as a client device is capable of handling. A <marker> element marks a specific point of time within a track. An <instrument> element sets the instrument source for a given section of the song.

Additionally, there may be audio elements which allow for the presentation and manipulation of audio in various ways in the media application. Audio elements can exist within a node-based structure, with some nodes being inputs for other nodes, which can also be inputs. A signal can be transmitted through the inputs and outputs of multiple nodes, affecting the audio path in various ways. An <audio> element sets the boundaries for an audio object, including inputs and outputs. A <node> element acts as a generic tag for audio nodes, with inputs and outputs to connect to other nodes. An <effect> element is a node that can affect the signal that is run through it. Examples of effects elements may be reverb, chorus, delay, and distortion effects. A <sample> element contains the raw data of an audio sample. Other song and audio elements may be contemplated, and in an exemplary embodiment there may be several dozens more elements comprising the media elements and resources for use in a media application.

Once the media application 115 requests specification instructions, the specification module 134 handles the specification retrieval from the media server 125. The specification module 134 determines the proper specification instructions that are requested from the media application 115 and locates them within the specification database 144. The specification module 134 then retrieves the specification instructions and sends them to the media application 115, which then stores the specification instructions in the specification database 125 within the client device 105.

In some embodiments, the media server 125 contains a processing engine 136. In some embodiments, the processing engine exists on the client device 105. In some embodiments, the processing engine is part of the media application 115 on the client device 105. The processing engine 136 processes the retrieved specification instructions, and retrieves media resource objects that the media resources define. A media resource object is an object that is retrieved from the media object repository 146, and is an object that embodies a concrete instantiation of an element that a media resource defines and points to on the server. First, processing the specification instructions involves scanning the specification set and having elements defined within the specification set. These defined elements are then transmitted to the media application 115 which uses them within the context of the application environment. For example, within a music application, the specification instructions may define a song, with multiple tracks within the song. Each track may have an instrument associated with it, and each instrument may have a defined sound that is created by specifying oscillators, envelopes, and other elements of an electronic instrument. Each track may also have music notation data that specifies how the instruments are triggered. The processing engine 136 processes all of these elements of the song, and sends them to the media application. Within the context of the media application, the song can be loaded, played back, and edited in various ways. A new specification set can then be generated based on the newly edited song, if desired.

Specific media resources may also be defined within the specification instructions, and their locations can be pointed to on the server. The deployment module 138 retrieves the media objects for those resources from the media object repository 146 and sends them to the media application 115 for use. In the preceding music example, the music notation data may trigger audio samples. Each audio sample may be specified within the specification instructions, including length of sample, waveform, encoding, channels, sample rate, and other sample attributes and information. In addition, a file path on the server may be specified, leading to the sample file's location within the media object repository 146. The deployment module 138 sends all of this sample information to the media application, where the samples can be used within the played back song in the environment that the media application has set up. In this way, objects can be defined in the context of a media specification, and deployed for use according to that specification.

Although the various methods, modules and repositories described within the exemplary model of FIG. 1 have been illustrated as occurring within either the client device 105 or the media server 125, it should be understood and contemplated that discrete elements described in FIG. 1 may occur on a client device rather than the server, and vice versa. In addition, it should be understood that multiple client devices may be present rather than a single client device 105, and that multiple media servers may be present rather than a single media server 125. For example, within a collaborative media application, more than one client device will receive specification instructions and media resource objects from a media server. As another example, media resource objects may be placed within repositories across dozens of different media servers. As yet another example, all processing and storage, including execution of the media application itself, may occur on the server rather than a client, with the client device merely using minimal browser resources to render content locally.

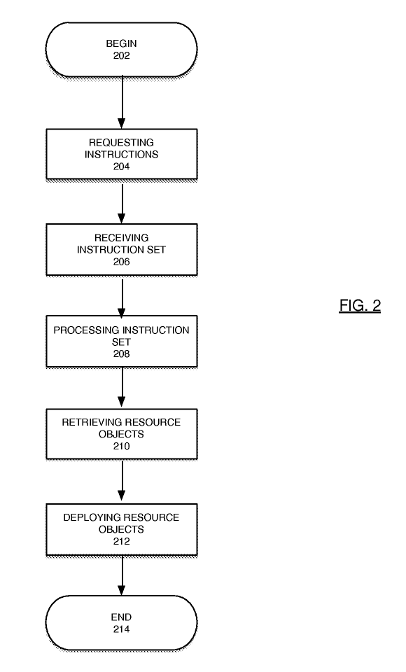

Turning now to FIG. 2, an operation of the specification processing and media resource deployment will be discussed in greater detail. FIG. 2 is a flowchart of steps in an exemplary method for defining and deploying media resources within a media application on a client device. The exemplary method begins at step 202 and continues to step 204. At step 204, the media application 115 requests instructions from the media server 125. The connection module 132 on the media server 125 then establishes a connection between the media server 125 and the client device 105. In some embodiments, an authentication procedure may be required in order to establish a secure connection with a trusted client device. The specification module 134 then retrieves the requested specification instructions from the specification database 144, and sends the specification instructions to the client device 105.

At step 206, the instruction set is received by the client device 105. The media application then stores the instructions within the specification database 125. The client device 105 thus has a file of the specification instructions within the local memory of the client device 105.

At step 208, the specification instructions are processed by the processing engine 136 within the media server 125. The specification instructions are scanned and the definitions of elements, as well as the structures of elements and subelements, are sent to the media application 115 for utilization within the context of the media environment. For example, if the specification instructions define a series of video clips to be played in a specific order, then a media application tasked with playing back the clips according to the specification in a particular environment will be sent all the defined elements necessary to do so.

At step 210, media resources are retrieved from the media server 125. Within the specification, media resources may be defined. For example, each video clip is considered a media resource that must be sent to the client device 105 in order for the video playback to occur within the media application 115. Within the specification instructions, the video clip is an asset within the media object repository 146 on the media server 125. This asset can be, for example, a pointer which points to a location within the media object repository 146. The deployment module 138 on the media server 125 ascertains the file location from the specification instructions, and retrieves the media object defined by the media resource from the media object repository 146.

At step 212, the deployment module 138 then sends the media object to the media application 115 on the client device 105. Along with the processed instructions, the media application 115 can now deploy all media objects that are specified to be deployed by the specification instructions.

The method then ends at step 214. In this way, the media application 115 is able to request a set of instructions from the media server, and receive a set of elements and instructions for setting up those elements within the media application 115. There can also be a plurality of media resources which can be retrieved in the form of media objects and sent to the media application 115 to be deployed within the media application environment. This provides a flexible, efficient system for specifying and deploying media resources within a media application.

FIG. 3A illustrates an exemplary embodiment of a series of song elements for deployment and presentation within a music creation environment. Specification instructions contain several elements, denoted by specific words set within brackets. These elements are the building blocks for a song that may be deployed, played back, and edited within a media application. As will be apparent to those of ordinary skill in the art when practicing the present technology other similar languages or schemes for providing such instructions and relationships between media elements are possible.

As presented in a formatting language, a specification is an instruction set that in some embodiments is intended to be a universal media package format. In some embodiments, the format can be extended upon in various ways. The design is flexible, such that users can easily manipulate the format and change various definitions, elements and structural aspects.

In some embodiments, specification instructions may grow large based on all of the data that is contained within them. In some embodiments, specifications require encryption and decryption of the contents. Also, specifications provide a way to include and exclude content, or to dynamically link content from remote locations.

Although the exemplary method herein describes elements within a music application for editing musical data and composing songs, many differing applications may exist for the same concept of specifications deploying media resources. One such differing application may be one that specializes in developing vector graphics. Still another may be utilized for the development of three-dimensional animation scenes.

The <song> element 310 defines a song object. A song object is a musical construct containing many discrete elements. The song element effectively sets the boundaries within the specification for a song object. Song objects can contain elements such as tracks, instruments, effects, clips, measures, and more. Song objects can also contain global attributes for the song, which are contained in their own formatting tags. A few examples follow.

The <tempo> tag establishes a tempo for the song according to a numerical value. For example, a <tempo value=“120”/> tag would indicate that the song's tempo is 120 beats per minute. Tempo elements can also be incrementally established by measures or special triggered events.

In addition, a <beatcount> element indicates how many beats are in the measures of the song, referring to the top half of a time signature in traditional musical notation. Further, a <beatvalue> element indicates how many beats are allocated to a quarter note, referring to the bottom half of a time signature in traditional musical notation. Finally, a <harmcontext> element indicates harmonic context of a song, which is effectively the musical key of the song.

Referring back to FIG. 3A, the <content> element 312 indicates the beginning of content for the song object. Content includes all tracks and other pertinent information for the song. A <content> tag is nested within a <song> tag, and determines the beginning of the content of the song, as opposed to the global song attributes discussed above.

A <track> element 314 is a container object for a specific track of the song. A track is a unique element of a song, and may contain measures and other subelements. A song may have any number of tracks which are not necessarily dependent upon each other. Tracks are further nested within the <content> element.

A <marker> element 316 marks a specific point of time in a song within a track. It may include a “startbeat” value which is a track-based starting time.

An <effect> element 318 may be used to manipulate client-specific audio effects. An effect may have a varied number of parameters which are named according to that client-specific effect. Effects are highly client-specific and depend upon their particular implementation within the media application 115 on the client device 105. A few examples of pre-defined effect elements may exist in some embodiments. One example is a “chorus” effect, with attributes possible such as rate, depth, width, and dry/wet which indicates the ratio of dry to wet signal that is present in the effect. Another example is a “delay” effect, which creates an echo effect controlled mainly by feedback and delay parameters. A third effect is “reverb”, which simulates reverberation within a room or chamber on the input signal. A reverb effect may include decay, damping, and bandwidth parameters. A fourth effect is “distortion”, which presents overdrive, wave shaping, and other functions on an input signal. This may include such parameters as gain, drive, and fuzz.

An <instrument> element 320 can set the instrument source for a given section of the song. When placed nested inside of a <track> element, the instrument will be used within that track. Instruments are highly client-specific and depend on the particular implementation of the media application 115 on the client device 105. Examples of pre-defined instruments may include nylon guitar, grand piano, electric guitar, and more.

<Instrument> elements, like other elements, may be sub-composed of other elements. For example, it is possible to find an <effect> element within an instrument. <Instrument> elements may also contain synthesizer nodes such as oschillators, <sample> nodes, or even waveform assets. Such assets could be written in manually or could be other pre-defined assets within the server.

A <clip> element 322 contains packets of musical information within the context of a track time. A clip may designate a start time, end time, loop length, and other parameters to indicate to the track how to process its contents.

In addition to these song elements, other song elements can exist which specify different aspects of a song or musical information within the song. For example, measures, notes, and chords may all be specified within their own element tags to indicate discrete elements within a song.

FIG. 3B illustrates an exemplary embodiment of a series of audio elements for deployment and presentation within a music creation environment. While FIG. 3A specified a number of structural elements within a song, FIG. 3B illustrates examples of audio elements for audio objects. In some embodiments, audio specification elements can outline a high level method to design and manipulate audio and waveforms.

The <audio> element 350 sets the boundaries for an audio object, including inputs and outputs. An audio object is encapsulated within the <audio> tag, which contains all audio nodes and networks. Audio objects are node-driven within the specification, with inputs and outputs for nodes. A media application 115 on a client device 105 will have a specific implementation that connects the inputs and outputs of nodes in a way that suits the application.

The <node> element 352 is a generic tag that can contain other nodes within an audio network. Parameters can include a name, inputs, and outputs. Any number of inputs or outputs may be defined within a node element. In some embodiments, other nodes may exist within a node element, and such nodes will not have access to any element outside of the node they are situated within.

An <effect> element is a kind of audio node that will always have at least one input and one output, and will affect the signal it is given in some way. Examples of <effect> elements may be <delay>, <reverb>, and <level>. Such elements as <delay> and <reverb> are <effect> nodes, but can also be composed of <effect> elements themselves, and contain elements of other <effect> elements within their definition. Some <effect> elements are building blocks for other <effect> elements.

A <sample> element 358 contains the raw data of an audio sample, as well as other relevant information associated with that audio sample. In some embodiments, it can include parameters such as encoding, channels, and sample rate. In addition, it includes a file reference parameter which is an asset within the media object repository 146 of the media server 125. An “encoding” parameter refers to the encoding format of the sample, such as an MP3 or WAV encoding format. A “channel” parameter indicates the number of channels in the sample, with two channels indicating stereo and one channel indicating mono output. A “sample rate” parameter indicates the rate at which the sample was sampled. In addition, a <starttime> element 360 designates the start time of a sample, while an <endtime> element 362 designates the end time of a sample.

While the exemplary elements discussed herein provide the fundamental blocks for audio elements and audio nodes within audio elements, many other possibilities exist for audio-based elements and nodes. The amount of audio elements possible varies only according to the depth of a particular application. In addition, other applications exist focusing on video elements in a similar way, or text elements in place of audio elements. It is appreciated that media resources and specifications can refer to a wide variety of media in the context of software applications, and is not limited merely to audio playback and manipulation.

FIG. 4B illustrates an exemplary embodiment of a specification element hierarchy, in which elements and subelements specify instructions for a media application 115. Within the song element hierarchy, the song elements described above in FIG. 3A are used.

Within the example song element hierarchy, several nested elements appear within a <song> element 410. The <song> element 410 acts as an element wrapper which sets the boundaries for all of the elements which are described within the <song> and </song> tags. A song can be described in formatting language within these boundaries. Shortly after the <song> tag 410, global parameters are defined, including tempo, beat count, beat value, and harmonic context. In this case, the tempo is set at 120 beats per minute, the beat count and beat value indicate a time signature of 3/4, and the harmonic context is set to the key of C minor.

A <content> element 420 then appears, which sets out the boundaries for the remaining content of the song. A <track> element 430, named “Piano part,” defines the nested elements for which a piano part will be described in formatting language. A <marker> element 440 marks a specific point in the piano track, in this case an intro point for the piano track. Within the intro marker, a grand piano instrument is defined by <instrument> element 450.

Also within the marker, two <effect> elements 460 define chorus and reverb effects to be applied within the intro. Thus, the audio signal of the grand piano instrument in the intro of the track will have both chorus and reverberation effects applied to it, altering the sound.

Additional structural elements of the song are described. A <measure> element 470 describes a specific measure of the intro portion of the track. Within the measure, a <clip> element 480 is defined, with a specific melody. The melody may be in the form of music notation data.

The closing tags 490 represent the ending of the respective measure, marker, track, content, and song elements. Once an element tag is closed, the boundary describing the respective element is set. For example, anything that appears nested within a <track> element affects only that track element, rather than affecting the song globally. Thus, the chorus and reverb effects may be applied to this particular track 430, but will not apply to additional tracks that appear in the song. Similarly, this particular grand piano instrument 450 will appear only within the intro marker 440, but not in other portions of the track 430, since it only appears nested within the marker element 440.

Using this simple hierarchy and similar such systems within the specification formatting, entire complex pieces of media may be described and granularly defined. A specification instruction set may build up an entire song from basic building blocks of song elements, audio elements, instrument elements, and more. This allows for a powerful, flexible, efficient, and universal way for describing and presenting media across many platforms.

A media application may also provide a collaborative environment, in which media resources are deployed to multiple users at once. In this embodiment, multiple client devices can request and receive specifications and media resources. In some embodiments, optimization can occur, such that the server is performing intensive processing rather than the individual client devices, which may be of differing processing power from each other. In some embodiments, a collaborative environment may allow for deployment and editing of media resources to occur in an asynchronous, parallel fashion.

FIG. 5A, and FIG. 5B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 5A illustrates a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B illustrates a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

We claim:

1. A computer-implemented method comprising:
receiving a request, by a client device, for instructions to present a plurality of media resource items;
sending to the client device specification instructions for the plurality of media resource items, wherein the specification instructions comprise presentation instructions for each media resource item as well as a definition and a server location for each media resource item;
processing specification instructions via a processing engine;
retrieving one or more media resource items from one or more server locations; and
sending the plurality of media resource items to the client device for presentation according to the processed specification instructions.

2. The computer-implemented method of claim 1, wherein processing the specification instructions via the processing engine comprises organizing the media resource items into a structured arrangement for presentation within a media application according to the definitions of the media resource items.

3. The computer-implemented method of claim 1, wherein the plurality of media resources comprises elements for rendering and presenting at least one of music, video, image, animation, text, and interactive code.

4. The computer-implemented method of claim 1, wherein the specification instructions comprise a formatted set of elements in a hierarchy.

5. The computer-implemented method of claim 1, wherein the presentation instructions comprise notation data for arranging a song.

6. The computer-implemented method of claim 5, wherein the media resource items comprise a representation of music notation data.

7. The computer-implemented method of claim 1, wherein the media resource items comprise instruments for generating sound.

8. The computer-implemented method of claim 1, wherein the presentation instructions comprise audio data for presenting and manipulating audio waveforms, and wherein the media resource items comprise elements for presenting and manipulating audio waveforms.

9. The computer-implemented method of claim 1, wherein the definition of each media resource item includes a time-based starting point and a time-based ending point for presentation of the media resource item.

10. The computer-implemented method of claim 1, wherein the presentation of the media resource items comprises presenting the media resource items within a media editing environment on the client device.

11. The computer-implemented method of claim 10, wherein the media editing environment is a collaborative application for multiple users.

12. A computer-readable medium storing computer executable instructions for causing a computer to perform the method comprising:
receiving a request, by a client device, for instructions to present a plurality of media resource items;
sending to the client device specification instructions for the plurality of media resource items, wherein the specification instructions comprise presentation instructions for each media resource item as well as a definition and a server location for each media resource item;
processing specification instructions via a processing engine;
retrieving one or more media resource items from one or more server locations; and
sending the plurality of media resource items to the client device for presentation according to the processed specification instructions.

13. The computer-readable medium of claim 12, wherein processing the specification instructions via the processing engine comprises organizing the media resource items into a structured arrangement for presentation within a media application according to the definitions of the media resource items.

14. The computer-readable medium of claim 12, wherein the plurality of media resources comprises elements for rendering and presenting at least one of music, video, image, animation, text, or interactive code.

15. The computer-readable medium of claim 12, wherein the specification instructions comprise a formatted set of elements in a hierarchy.

16. The computer-implemented method of claim 1, wherein the presentation instructions comprise notation data for arranging a song.

17. A product comprising:
a computer readable medium; and
computer readable instructions, stored on the computer readable medium, that
when executed are effective to cause a computer to:
receiving a request from a client device for instructions to present a plurality of media resource items;
sending, via a specification engine, specification instructions for the plurality of media resource items, wherein the specification instructions comprise presentation instructions for each media resource item as well as a definition and a server location for each media resource item;
processing, via a processing engine, the specification instructions, wherein the processing comprises organizing the media resource items for presentation according to the definitions of the media resource items;
retrieving, via a resource engine, one or more media resource items from one or more server locations; and
sending, via a deployment engine, the plurality of media resource items to the client device for presentation according to the processed specification instructions.

18. The product of claim 17, wherein the instruction set comprises a formatted set of elements in a hierarchy.

19. The product of claim 17, wherein the plurality of media resources comprises elements for rendering and presenting at least one of music, video, image, animation, text, or interactive code.

20. The product of claim 17, wherein the presentation instructions comprise notation data for arranging a song.

21. A computer-implemented method comprising:
receiving a request, by a client device, for instructions to present a plurality of media resource items within a media application;
sending to the client device specification instructions for the plurality of media resource items, wherein the specification instructions comprise presentation instructions for each media resource item as well as a definition and a server location for each media resource item, and wherein the specification instructions comprise a formatted set of elements in a hierarchy;
processing specification instructions via a processing engine, wherein the processing comprises organizing the media resource items for presentation according to the definitions of the media resource items;
retrieving one or more media resource items from one or more server locations; and
sending the plurality of media resource items to the client device for presentation according to the processed specification instructions.

22. The computer-implemented method of claim 21, wherein the plurality of media resources comprises elements for rendering and presenting at least one of music, video, image, animation, text, or interactive code.

23. The computer-implemented method of claim 21, wherein the presentation instructions comprise notation data for arranging a song.

24. The computer-implemented method of claim 21, wherein the presentation instructions comprise notation data for arranging a song.

25. The computer-implemented method of claim 24, wherein the media resource items comprise a representation of music notation data.
